(19) United States
(12) Patent Application Publication
(10) Pub. No.: US 2024/0309583 A1
(43) Pub. Date: Sep. 19, 2024

(54) SYNTHETIC TURF AND WEAVING METHOD

(71) Applicant: NRT IÇ VE DIS TICARET ANONIM SIRKETI, Istanbul (TR)

(72) Inventors: Ibrahim NALBANT, Istanbul (TR); Emrah YURTBASI, Istanbul (TR)

(21) Appl. No.: 18/546,758

(22) PCT Filed: Apr. 30, 2021
(86) PCT No.: PCT/TR2021/050415

§ 371 Date: Aug. 16, 2023

(30) Foreign Application Priority Data
Mar. 4, 2021 (TR) 2021/004261

(51) Int. Cl. D06N 7/00

(52) U.S. Cl. CPC D06N 7/0065

(57) ABSTRACT

The invention relates to a synthetic turf weaving method used in synthetic turf weaving on 5/32, 3/16, 5/16, ⅜, ⅝, ¾ inch cut pile machines.

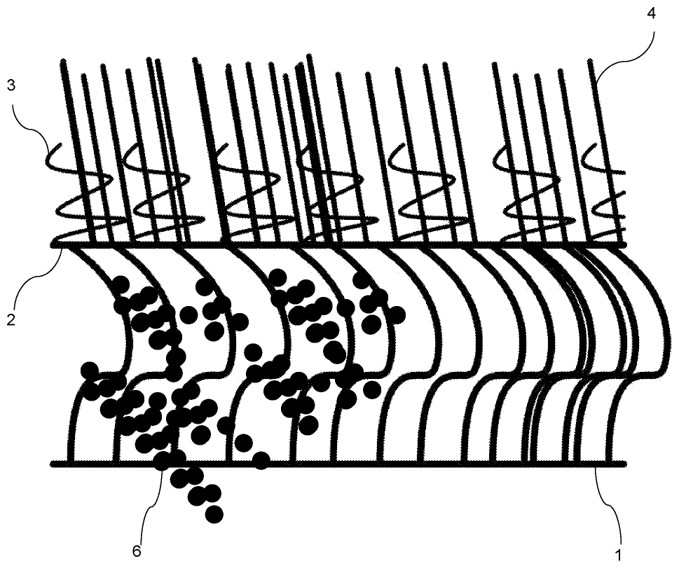

### TECHNICAL FIELD

The invention relates to a synthetic turf weaving method used in synthetic turf weaving processes on 5/32, 3/16, 5/16, ⅜, ⅝, ¾ inch cut pile machines.

### STATE OF THE ART

Synthetic turf is woven at once and filling materials are used so as to prevent injuries of the players in the applications included within the state of the art. The disadvantages of the synthetic turf included in the state of the art are as follows; the carcinogenic effects of these filling materials, getting in people's feet during play, smelling in hot weather, distorting the visual appearance on the field. Since the synthetic turf we produce with the inventive weaving method, provides the same performance as the filled system without filling, it eliminates all the disadvantages of the filled system due to filling.

In document US20070237921, an artificial turf system comprises a pile fabric with many backing threads, vertical synthetic strips so as to form at least one pile yarn (weave) and a backing layer and represent glass blades extending upwards from a top surface of a plurality of backing layers, a filler layer from particulate material occasionally placed between the vertical strips and on the backing layer and the filling layer length of a top surface is greater than one inch from the top surface of the backing layer. The synthetic surface may contain a velvet fabric that has a plurality of backing yarns woven with a plurality of velvet yarns so as to form a backing layer and a plurality of upright synthetic strips representing blades of grass extending upward from a top surface of the yarn. It may consist of a plurality of strips of the first type and the second type.

### DESCRIPTION OF THE INVENTION

Polyethylene-based material, preferably felt, polypropylene or polyethylene-based base fabric, in appropriate dimensions (preferably 4 m) is mounted on the carpet woven using 1500/2500 gr 5000/10.000 dtex synthetic turf yarn per m2 in 5/32 or 3/16 inch cut pile weaving with 10 to 20 mm pile length produced by the inventive weaving method. A second weaving between 20/40 mm in 5/16, ⅜, ⅝ or ¾ machines is carried out on this new mounted base and thus it replaces the filling in the fields. Therefore, ready filled turf is sent to be applied to the field and it can be used directly without using further granule, sand after it is adhered.

The advantages and easiness of synthetic turf products produced according to the invention compared to other synthetic turf products produced until today are as follows; An aim of the invention is to keep the structure and thus the visual appearance of the synthetic carpet, which is the most important element of the field that has been used intensely for many years.

Another aim of the invention is to prevent problems such as odor and dyeing due to granules in hot weather.

Another aim of the invention is to reduce the amount of used material preferably granular filling material and thus to reduce costs.

Another aim of the invention is to prevent static electricity.

Another aim of the invention is to use additional granule, organic granule, cork filler, EPDM can be used in the inventive product, if desired, so as to create natural turf in the used product and to contribute to the performance filling.

Another aim of the invention is to provide the same standards (visual, shock absorption, splash) with much less amount of granules or filler material ensuring performance, by means of the separator used between the two bases in case filler is used.

### REFERENCE LIST

1—Surface coating
2—Base material
3—Weaving
4—Separating layer
5—Granular filling
6—Curly yarn weaving
7—Straight yarn weaving

### DESCRIPTION OF FIGURES

The sole FIGURE is a synthetic turf section view.

### DETAILED DESCRIPTION OF THE INVENTION

The invention is a multi-layered turf structure consists of the following; preferably at least one Surface Cover (1), preferably at least one Base Material (2), Weaving (3), preferably at least one Separating Layer (4), preferably Granule Filling (5), Curly Yarn Weaving (6) and Straight Yarn Weaving (7).

These parts preferably consist of the following that ensure the weavings and/or the elements in the layers in the multi-layered synthetic turf fabric in the system located at the bottom not to disperse and make the synthetic turf fabric long-lasting; latex surface coating (1), base material (2) that provides the stabilized filling on the surface where the turf texture is located, separating layer (4) preferably felt that prevents weaving (3) with short yarns on the base material reducing the use of extra filling and plastic, prevents static electricity barrier filler, such as sand organic granule at the top, positioned between the woven fabric (3) and the granule filling (5) and acts as a separating effect, prevents anti-static filling such as sand organic granule on the top from falling down, granular filling (5) preferably organic that reduces friction and reduces static electricity, providing a natural appearance to the turf, performance filler curly yarn weaving (6) and straight yarn weaving (7) that determines the visuality of the product and determines the ball rolling, riding and bouncing performances.

The structure of the system is designed as follows; preferably latex Surface Coating (1) located at the bottom of the Curly Turf Weaving (6) and the Straight Turf Weaving (7), which prevents the dispersion and is placed under the Base Material (2), Base Material (2) that houses the weaving thereon, Weaving (3) that prevents the use of unnecessary filling material and plastic and creates a layer with short yarns on the Base Material (2), preferably the Felt Separator Layer (4), positioned on the fabric (3) and preventing the filler from falling down, preferably organic Granule Filler (5) preferably on the Separator Layer (4), at the depth reaching the Base Material (2), the Curly Turf Weaving and the Straight Turf Weaving (7) and reduces the friction and static electricity on the Separating Layer (4), providing a natural appearance to the turf, Curly Turf Weaving (6) and Straight Turf Weaving (7).

The use of double weaving and separating layer (4) ensures the Curly Turf Weaving (6) and Straight Turf Weaving (7) yarns, which remain on the separating layer (4), without filling, are in accordance with the standards, and achieve the desired performances. It is not required to use sand, and even if used, the use of filler (sand, granule) is reduced to very little by means of the double weaving and the separating layer (4).

### INDUSTRIAL APPLICABILITY OF THE INVENTION

A—Making the First (Short) Weaving: Weaving of PP or polyethylene between 3000/12000 dtex with a 5/32 or 3/16 layer inch machine at 15/40 density range to form a stabilized filling of 1500/2500 g pile weight.
B—Separating Layer Lamination: the process of integrating a felt with appropriate dimension (preferably 4 m wide) or base cloth by stretching the same to the lower base and sewing or gluing the same on both sides.
C—Second (Curly-Straight) Weaving: It is formed using ⅜, 5/16, ⅝, or ¾ inch cut pile weaving machines, by curly and straight monofilament or fibrillated threads by attaching two strands from a needle or individual needles. It can be produced on the bottom weaving base by using threads in the order of 4000/20.000 dtex in the range of 1000/3000 gr in the density range of 10 to 25 between 25 and 50 mm.
D—Creating the Plastering Layer,
E—Organic granule: It is the form of pouring of granules that assist in preventing static electricity generation by reducing friction.

1. A synthetic multi-layered turf and weaving structure, comprising at least one surface cover, at least one base material, at least one weaving, at least one separating layer, granule filling, at least one curly yarn weaving and straight yarn weaving.

2. The synthetic turf and weaving structure according to claim 1, wherein the base material provides the stabilized filling in the system, the short yarn weaving forms a filling layer made on the base material, the separating layer is placed on the surface of the weaving, provides a separating effect of the filling that prevents static electricity, such as sand granule, part of the curly yarn weaving remains on this separating layer and determines the ball rolling, riding and jumping performances that determine the visual of the product, the straight yarn weaving, the surface coating prevents the synthetic grass yarns made on the bottom surface of the base material from coming off or falling off, granular filling reduces the friction on the top of the formed structure, reduces static electricity, provides natural appearance to the turf.

3. A method for producing the synthetic multi-layered turf and weaving structure according to claim 1, comprising making the first weaving for providing filling on the base material, placing a separating layer on the weaving, placing curly and straight yarns on the separating layer by repeating curly yarn weaving and straight yarn weaving.

4. The synthetic turf and weaving structure according to claim 1, wherein the woven yarns reach up to the base material in weaving, curly yarn weaving and straight yarn weaving, which prevents the dispersion of yarns and ensures high durability of synthetic grass texture.

5. The synthetic turf and weaving structure according to claim 1, wherein the separating layer is placed on the surface of the weaving, makes the separating effect, prevents static electricity blocking filler preferably such as sand organic granule to fall down, can be used in different locations and/or can be used between different layers.

6. The synthetic turf and weaving structure according to claim 1, wherein the separating layer is integrated by sewing or bonding the same on both sides by stretching to the bottom base of the felt or base cloth of suitable width, formed from felt, polypropylene and/or polyethylene.

7. The synthetic turf and weaving structure according to claim 1, wherein the granular filling is environmentally friendly, and organic granule filler in synthetic grass tissue used in large areas is used.

8. The synthetic turf and weaving structure according to claim 1, wherein an upper weaving consisting the curly yarn weaving and the straight yarn weaving is formed by attaching at least one thread to curly and straight monofilament and/or fibril, from a needle or to individual needles by using ⅜, 5/16, ⅝ or ¾ inch cut pile weaving machines.

9. The synthetic turf and weaving structure according to claim 1, wherein two or more different dtexes longer than the sub woven, made of curly and straight yarns, of different density and weight are used.
